(19) United States
(12) Patent Application Publication
(10) Pub. No.: US 2019/0180753 A1
(43) Pub. Date: Jun. 13, 2019

(54) ANALYSIS OF COLLABORATIVE DIALOG DATA STRUCTURES FROM SPEECH PROCESSING COMPUTER SYSTEM

(71) Applicant: CA, Inc., New York, NY (US)

(72) Inventors: Preethi Raja, Hyderabad (IN); Jagadeeshwaran Karunanithy, Salem (IN); Shamayel Mohammed Farooqui, Hyderabad (IN); Jagadishwara Chary Sriramoju, Hyderabad (IN); Sai Kumar Bochkar, Nizamabad (IN)

(73) Assignee: CA, Inc., New York, NY (US)

(21) Appl. No.: 15/838,483

(22) Filed: Dec. 12, 2017

(51) Int. Cl. G10L 15/26; G10L 15/22; G10L 15/08; G10L 19/02; G06Q 10/06

(52) U.S. Cl. CPC G10L 15/26; G10L 15/22; G06Q 10/0635; G10L 19/02; G06Q 10/063118; G10L 15/08

(57) ABSTRACT

A collaborative speech processing computer obtains data packets of sampled audio streams. The data packets are forwarded to a speech-to-text conversion server via a data network. Data packets are received via the data network that contain text strings converted from the sampled audio steams by the speech-to-text conversion server. The text strings are added to a dialog data structure in a repository memory. Elements of the dialog data structure are processed through a project ruleset to generate task metrics. Updating of elements of a project data structure in a database server is controlled based on the task metrics generated.

### TECHNICAL FIELD

The present disclosure is related to speech processing computer systems and more particularly to voice recognition servers.

### BACKGROUND

In software development and some other product development environments, team members huddle together each morning for a stand-up meeting where they review progress and essentially re-plan the project. During the daily meetings, which are called “scrums,” a scrum master asks the team members these three questions that can include: what did you do yesterday; what will you do today; are there any impediments in your way. The scrum master functions to, for example: help the team to reach consensus for what can be achieved during a specific period of time; help the team to reach consensus during the daily scrum; help the team to stay focused and follow the agreed-upon rules for daily scrums; remove obstacles that are impeding the team's progress; and protect the team from outside distractions.

Tracking progress toward completing project tasks, task issues raised by team members, and the contributions by individual team members toward those tasks can be a time consuming process, can interfere with the ongoing collaboration among team members, and can impede the free flowing discussions that are considered important to providing a supportive project environment.

### SUMMARY

Some embodiments disclosed herein are directed to methods by a collaborative speech processing computer. Data packets of sampled audio streams are obtained. The sampled audio streams are forwarded to a speech-to-text conversion server via a data network. Packets are received via the data network that contain text strings converted from the sampled audio steams by the speech-to-text conversion server. The text strings are added to a dialog data structure in a repository memory. Elements of the dialog data structure are processed through a project ruleset to generate task metrics. Elements of a project data structure in a database server are maintained based on the task metrics.

Some other related embodiments disclosed herein are directed to a collaborative speech processing computer. A network interface is configured to communicate with a speech-to-text conversion server. A processor is connected to receive the data packets from the network interface. A memory stores program instructions that are executable by the processor to perform operations. The operations include obtaining data packets of sampled audio streams. The sampled audio streams are forwarded to the speech-to-text conversion server via the network interface. Data packets containing text strings converted from the sampled audio steams by the speech-to-text conversion server, are received via the network interface. A project task is selected from among a plurality of project tasks defined in a project database. A set of task progress keywords is selected from among a plurality of sets of task progress keywords that have been defined for respective ones of the plurality of project tasks, based on the project task selected. Words in the text strings are compared to the task progress keywords in the set selected. Task metrics are generated based on which of the words in the text strings match which of the keywords of the task progress keywords is the set selected. Elements of a project data structure in a database server are maintained based on the task metrics.

Some other related embodiments disclosed herein are directed to another collaborative speech processing computer that performs operations that include obtaining data packets of sampled audio streams, and forwarding the sampled audio streams to the speech-to-text conversion server via the network interface. Data packets containing text strings converted from the sampled audio steams by the speech-to-text conversion server, are received via the network interface. Speech metrics are determined based on processing the text strings in the dialog data structure through a speech analysis ruleset. Changes are tracked over time between the speech metrics generated for a plurality of collaboration meetings between persons that are performed over the time. Task metrics are generated based on determining whether the tracked changes over time between the speech metrics satisfy a project rule among a project ruleset. Elements of a project data structure in a database server are maintained based on the task metrics.

It is noted that aspects described with respect to one embodiment disclosed herein may be incorporated in different embodiments although not specifically described relative thereto. That is, all embodiments and/or features of any embodiments can be combined in any way and/or combination. Moreover, methods, collaborative speech processing computer, and/or computer program products according to embodiments will be or become apparent to one with skill in the art upon review of the following drawings and detailed description. It is intended that all such additional methods, collaborative speech processing computer, and/or computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a block diagram of a computer system that includes a collaborative speech processing computer that operationally interfaces with a project database and a natural language speech-to-text server in accordance with some embodiments;

FIG. 2 is a combined data flow diagram and flowchart of operations that may be performed by wireless user terminals, the collaborative speech processing computer, and the natural language speech-to-text server of FIG. 1 in accordance with some embodiments;

FIG. 3 is a combined data flow diagram and flowchart of some other operations that may be performed by the collaborative speech processing computer, the natural language speech-to-text server, and the project database of FIG. 1 in accordance with some other embodiments;

FIG. 4 is a combined data flow diagram and flowchart of some other operations that may be performed by the project database and the collaborative speech processing computer of FIG. 1 in accordance with some other embodiments;

FIG. 5 is a block diagram of a speech processing computer system that is configured in accordance with some embodiments; and

FIG. 6 is a block diagram of a user terminal that is configured in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

According to various embodiments of the present disclosure, a collaborative speech processing computer obtains data packets of sampled audio streams. The sampled audio streams are forwarded to a speech-to-text conversion server via a data network. Data packets are received via the data network that contain text strings converted from the sampled audio steams by the speech-to-text conversion server. The text strings are added to a dialog data structure in a repository memory. Elements of the dialog data structure are processed through a project ruleset to generate task metrics. Elements of a project data structure in a database server are maintained based on the task metrics.

The collaborative speech processing computer may be part of a virtual scrum master system. For example, in some embodiments a virtual scrum master is provided as an electronic tool (e.g., server) that facilitates the textual recordation and organization of spoken conversations by scrum meeting attendees. The virtual scrum master tool listens to spoken conversations by scrum meeting attendees, converts a stream of audio samples of the spoken conversations to a data packets containing digital samples of the audio stream, dynamically identifies speakers during the conversations, and associates identifiers for the speakers to the converted text strings. The virtual scrum master tool can then organize the converted text strings with the associated speaker identifiers into a scrum knowledgebase. The scrum knowledgebase can be mined for project planning, tracking progress attributable to individual team members, identifying risks with individual project deliverables, etc.

Some embodiments are further directed to a virtual scrum master server that generates risk metrics based on the sampled audio from speakers and the converted conversation text from the speech-to-text conversion server. The risk metrics are stored in data structures with associations to the converted conversation text in a scrum knowledgebase.

The speech metrics that determined by the virtual scrum master server can include, but are not limited to, any one or more of:
1. spectrum analysis (e.g., pitch, frequency)
2. number words between pauses
3. spoken rate of words between pauses
4. length of pauses
5. rate of interruptions due to time-overlapping speakers, and may further include duration of the continuing time-overlapping speech before one or more speakers stopped talking;
6. word choice metrics for particular tasks discussed; and
7. completeness or thoughts expressed for particular tasks discussed.

The risk metrics that are determined by the virtual scrum master server based on the speech metrics can include, but are not limited to, any one or more of:
1. Speech character change metrics indicating whether and by how much the speech metrics changed from one or more historical scrum meetings and a present scrum meeting, and which may further be determined based on assessment of speech metric changes tracked for particular tasks over time.
2. Confidence metrics for speakers, which may be compared to time history of confidence metrics for those speakers and a determined result of historical effectiveness of what was said with corresponding confidence metrics to what was subsequently accomplished by those speakers.
3. Alertness metrics for speakers, which may be compared to time history of alertness metrics for those speakers and a determined result of historical effectiveness of what was said with corresponding alertness metrics to what was subsequently accomplished by those speakers.

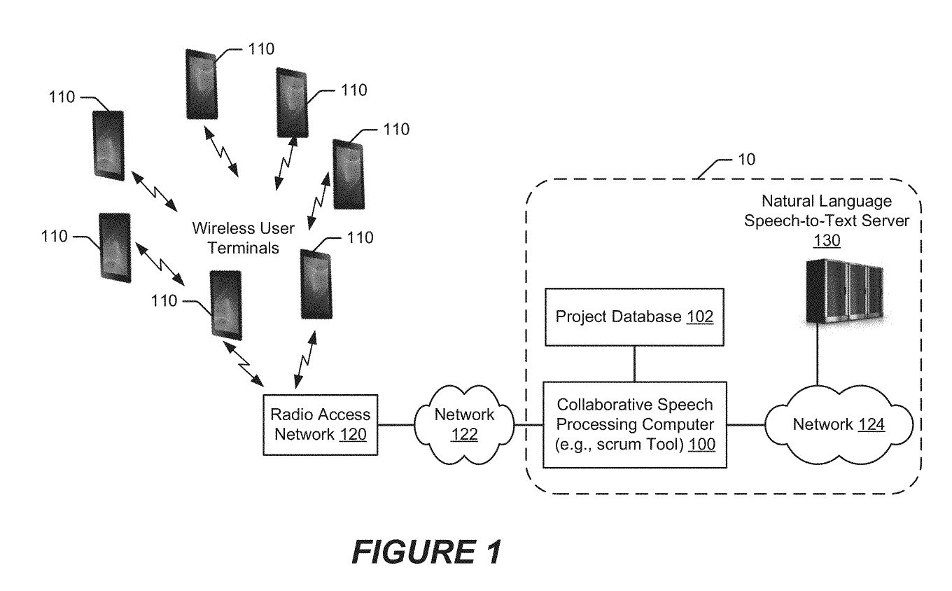

The virtual scrum master server can generate risk scores that provide one or more of, without limitation, identification of risk of a defined task being completed by a defined date and/or defined subparts of a task being completed by individual team members, and/or assessment of the predicted time of completion of tasks and/or subparts thereof. These and other related embodiments will be described in further detail below with regard to FIGS. 1 through 6.

FIG. 1 is a block diagram of a computer system that includes a collaborative speech processing computer 100 that operationally interfaces with a project database 102 and a natural language speech-to-text server 130 in accordance with some embodiments. The collaborative speech processing computer 100 may form a virtual scrum master tool (computer server) in accordance with some embodiments. The collaborative speech processing computer 100 may communicate through a data network 124, e.g., private network and/or public network (Internet), with the natural language speech-to-text server 130.

One approach includes having scrum meeting attendees set their wireless terminals 110, e.g., mobile phones, tablet computers, etc., on a table nearest their seated/standing position. The collaborative speech processing computer 100 forms a communication link through a radio access network 120 (e.g., Bluetooth, WiFi, and/or cellular radio interface) with the wireless terminals 110. Scrum applications 200 on the wireless terminals 110 generate data packets of sampled audio streams which are sent to the collaborative speech processing computer 100 with identifiers of the wireless terminals 110 and/or the user names that have been registered in the scrum applications 200 and/or as user information registered in the wireless terminal settings. The collaborative speech processing computer 100 correlates mobile phone identifiers to scrum meeting attendees' names. The collaborative speech processing computer 100 sends the sampled audio streams to the remote networked natural language speech-to-text server 130, e.g., such as to APIs of natural language speech-to-text servers provided by Google, Apple, and/or Microsoft. The collaborative speech processing computer 100 receives responsive conversation text strings from the natural language speech-to-text server 130, and associates speaker identifiers with the conversation text. The conversation text strings are stored in a project database 102 or, more generally, in a dialog data structure in a repository memory, with speaker identifiers.

The radio access network 120 may be connected to the collaborative speech processing computer 100 through a data network 122, which may be part of the data network 124. In some other embodiments described below, instead of using wireless user terminals to sense voices, one or more microphones can be positioned among the users to provide audio streams that are sampled to generate the data packets provided to the collaborative speech processing computer 100. Although illustrated separately for ease of reference, one or more of the functions disclosed herein for the collaborative speech processing computer 100, the project database 102, and/or the natural language speech-to-text server 130 may be combined within a computer system 10. The user terminals 110 may alternatively correspond to laptop computers, desktop computers, tablet computers, and/or other computer communications equipment that can be connected by wired network lines, e.g., Ethernet, to the collaborative speech processing computer 100. For example, a meeting may partially or entirely include remotely located persons who are teleconferencing together for a scrum session brother collaboration meeting.

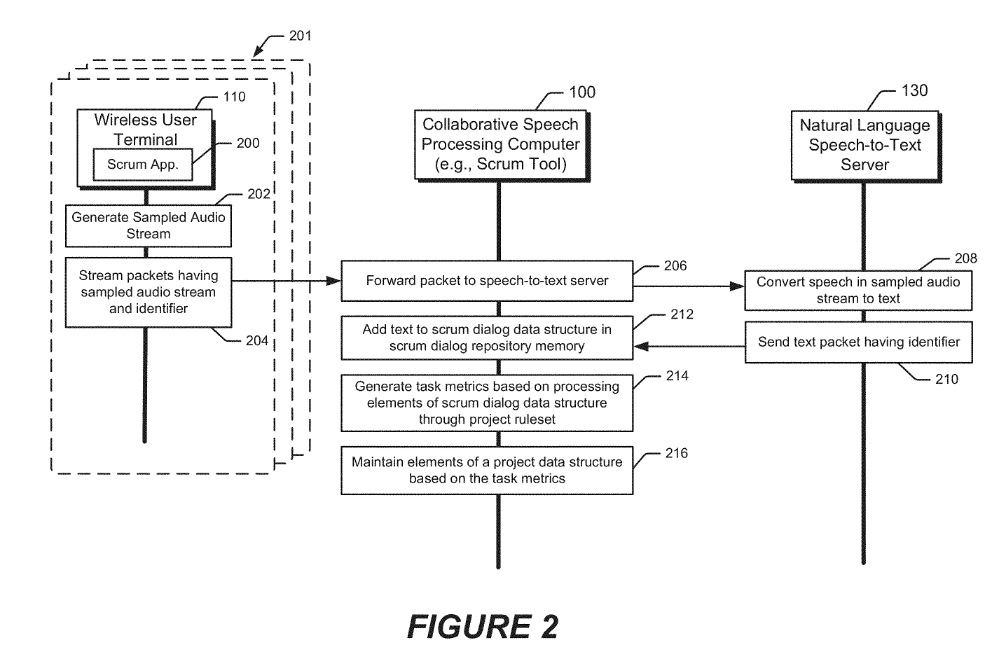

FIG. 2 is a combined data flow diagram and flowchart of operations that may be performed by wireless user terminals 110, the collaborative speech processing computer 100, and the natural language speech-to-text server 130 of FIG. 1 in accordance with some embodiments. Although a single user terminal 110 is illustrated in FIG. 2, is be understood that the functionality illustrated therein may be replicated across a plurality of computer terminals 201.

Referring to FIG. 2, the wireless user terminal 110 executes a scrum application 200 that performs the illustrated operations, which include generating 202 a sampled audio stream from output of a microphone that may be part of the terminal or operationally interconnected thereto, e.g., Bluetooth headset. Data packets are generated that contain the sampled audio stream and may further contain an identifier for the user terminal 110 and/or for a registered user or subscriber. The data packets are communicated (e.g. streamed) 204 to the collaborative speech processing computer 110, such as by packet radio communications through the radio access network 120 which are forwarded through the network 122.

The collaborative speech processing computer 100 receives the data packets containing the sampled audio stream from the wireless user terminal 110, and forwards 206 the data packets, e.g., forwards the sampled audio streams contained in the data packets, to the natural language speech-to-text server 130 via the data network 124. The forwarding 206 may include sending messages to the server 130 that provide the sample audio streams to a speech recognition application programming interface (API) of a speech recognition application executed by the server 130, e.g., such as to APIs of natural language speech recognition applications hosted by Google, Apple, and/or Microsoft.

The natural language speech-to-text server 130 recognizes and converts 208 speech that is contained in the sampled audio streams into text strings, and sends 210 data packets containing the text strings through the data network 124 to the collaborative speech processing computer 100.

The collaborative speech processing computer 100 receives the data packets containing the text strings, and adds 212 the text strings to a dialog data structure in a repository memory. The collaborative speech processing computer 100 processes 214 elements of the dialog data structure through a project ruleset to generate task metrics, and maintains 216 elements of a project data structure in the database server 102 based on the task metrics that are generated. Operations to maintain the elements in the project data structure can include adding the task metrics, mathematically combining or other combining (e.g., appending) the task metrics with information residing in the project data structure, and/or replacing information residing in the project data structure with the newly generated task metrics. Content of at least a portion of the project data structure may be output to a display device for display.

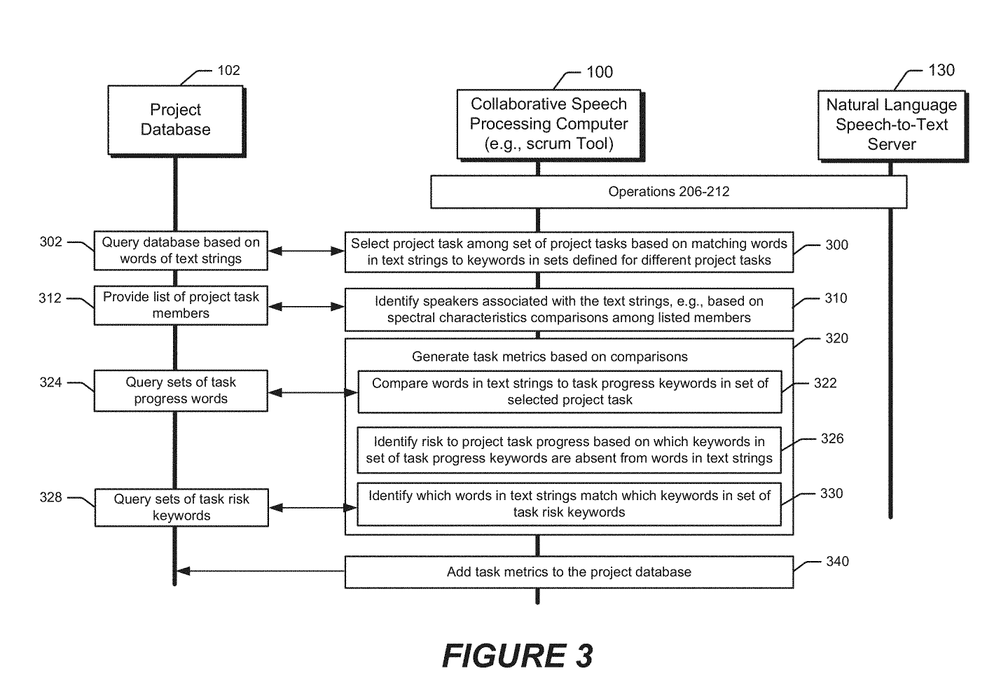

FIG. 3 is a combined data flow diagram and flowchart of some other operations that may be performed by the collaborative speech processing computer 100, the natural language speech-to-text server 130, and the project database 102 of FIG. 1 in accordance with some other embodiments.

Referring to FIG. 3, the collaborative speech processing computer 100 and the natural language speech-to-text server 130 can perform the operations 206-212 described above for FIG. 1. The computer 100 may further operate to identify a project task that is being discussed in the text strings. Identification of the project task can assist with identifying speakers who are associated with the text strings that are contained in the data packets. As will be described in further detail below, various further embodiments are directed to operations for dynamically identifying speakers during meetings, such as during scrum group discussions, and correlating the speaker identifiers with the text segments that are later returned by the natural language speech-to-text server 130 through natural language speech-to-text conversion.

The collaborative speech processing computer 100 can operate to identify speakers associated with the text strings contained in the data packets, and add the identifiers of the associated speakers to the dialog data structure in the repository memory with indications of their respective associations to the text strings.

In some embodiments, the collaborative speech processing computer 100 queries 302 the project database 102 based on words contained in the text strings that are received in the data packets from the natural language speech-to-text server 130. The project database 102 can store sets of keywords that have been defined for a plurality of project tasks. For each project task, the project database 102 can define keywords that characterize task milestone names, product names, product component names, product interface names, task member (person) names, supplier names, customer names, and other information that can characterize project tasks, work that is anticipated to be performed to complete the project tasks, and associated persons and/or entities.

As will be explained in further detail below, the collaborative speech processing computer 100 can rely on the results of querying the project database 102 to identify persons who are likely to have spoken the converted text strings. Identifying the speakers can be particularly advantageous for enabling tracking of progress toward completing project tasks, task issues raised by individual team members, and the contributions by individual team members toward those tasks. Moreover, audio signals from the identified task associated speakers may be handled operationally differently than those from other speakers.

To identify one of the speakers associated with one of the text strings contained in the data packets, the collaborative speech processing computer 100 can operate in combination with the project database 102 to select 300 a project task from among the project tasks that are defined in the project database 102 based on a closest matching of words in the one of the text strings to a set of keywords for the project task that is among sets of keywords that have been defined for the plurality of project tasks.

The operations to select 300 a project task from among a plurality of project tasks that are defined in the project database 102 can be based on identifying closeness of matching between words in one of the text strings to different sets of keywords that have been defined for respective ones of the plurality of project tasks. The project database 102 can define a set of keywords that are associated with each project task (e.g., keywords corresponding to task descriptions, milestones, dates, product interfaces, supplier names, customer names, etc.), and therefore different project tasks typically have different sets of keywords. The project database 102 can include a list of persons who are members of a project, can identify persons who are responsible for which tasks of a project, and can identify which sub-tasks each person is responsible for handling. The project database 102 may identify functional reporting structures, including which who is responsible for managing a project, task, and/or sub-task and overseeing progress by certain identified other persons. A person can therefore be identified as the speaker or as a candidate speaker from among a defined group of possible speakers who is/are associated by the project database 102 with the project task that was selected.

When the project database 102 identifies a single person being associated with the selected project task, that person can be identified as the speaker of the text string received in the data packet. The collaborative speech processing computer 100 can store (e.g., 212 in FIG. 2 and/or 340 in FIG. 3) the one of the text strings and an identifier of the person who is identified as the speaker, to the project data structure 102 with a defined association to the project task selected.

When the project database 102 identifies more than one person being associated with the selected project task, the operations to identify 310 the speaker may further include comparing spectral characteristics of a voice that is contained in the sampled audio stream, which was converted to the one of the text strings, to the spectral characteristics that have been earlier defined in the project database 102 for each of the persons who are identified by the project database 102 as being associated with the project task that was selected 300. Based on a relatively closeness of the comparisons of spectral characteristics, a person is then selected as being the speaker from among the plurality of persons who are identified by the project database 102 as being associated with the project task that was selected. For example, the project database 102 can contain a data structure that associates persons with project tasks, and that further associates therewith information that characterizes spectral characteristics of each of those persons. The computer 100 can characterize the spectral characteristics of a voice in the sampled audio stream corresponding to the text string, and compare the characterized spectral characteristics to the information that is stored in the project database 102 for those persons who are associated with the selected project task. Characterization of the spectral characteristics of a voice can include, without limitation, characterizing the frequency waveform of a person's voice pronouncing certain defined words, characterizing the rate of words spoken by the person, characterizing spectral intonations formed by the person pronouncing certain defined words, etc.

In a further embodiment, the comparison of the spectral characteristics of the voice contained in the sampled audio stream to spectral characteristics that are defined for the persons who are defined by the project database 102 as being associated with the project task that was selected, can include comparing a spoken rate of words that are contained in the sampled audio stream, which was converted to the one of the text strings, to spoken rates of words that are defined for the plurality of persons who are defined by the project database 102 as being associated with the project task selected. For example, different persons can often be characterized by different speech rates (e.g., number of words spoken of a defined time period), and the characteristic speech rate for a defined person can be learned by the collaborative speech processing computer 100 and/or another system component and stored as information associated with that person's identifier in the project database 102.

In another further embodiment, the comparison of the spectral characteristics of the voice contained in the sampled audio stream to spectral characteristics that are defined for the persons who are defined by the project database 102 as being associated with the project task that was selected, can include comparing a frequency spectrum waveform in the sampled audio stream, which was converted to the one of the text strings, to frequency spectrum waveforms that are defined for the plurality of persons who are identified by the project database 102 as being associated with the project task that was. For example, different persons can often be characterized by different voice frequency spectrum waveforms (e.g., voice pitch and frequency waveform for various defined spoken words), and the characteristic voice frequency spectrum waveform for a defined person can be learned by the collaborative speech processing computer 100 and/or another system component and stored as information associated with that person's identifier in the project database 102.

In another further embodiment, when the packets of sampled audio streams are received from wireless user terminals 110, the collaborative speech processing computer 100 parses the packets to determine terminal identifiers of the wireless user terminals 110. Names of the speakers are determined based on the terminal identifiers, such as by using the terminal identifiers to look up subscriber names in a subscriber database. The subscriber database may be a cellular home subscriber registry that is queried using the mobile identifier for a cellular phone. The names of the speakers are embedded as metadata in files of the sampled audio streams forwarded to the speech-to-text conversion server 130, and the speakers who are associated with the text strings contained in the packets that are received are identified based on metadata returned by the speech-to-text conversion server 130.

Various operations are now explained that can be performed by the collaborative speech processing computer 100 and/or by the project database 102 to generate (214 of FIG. 2) task metrics based on processing elements of the dialog data structure through a project ruleset. In FIG. 3, the task metrics can be generated 320 based on various comparisons.

The project database 102 can store task progress keywords that are associated with a project task in which are associated with indicating various defined levels of progress toward completing the project task. Because different project tasks have different associated named activities that need to be completed to constitute having reached various defined levels of progress, different project tasks can therefore be associated with different sets of task progress keywords. The project database 102 can therefore store sets of task progress keywords, with each set being associated with a different one of the defined project tasks.

In one embodiment, the collaborative speech processing computer 100 can use the identity of the project task that was selected 300, to query 324 the project database 102 to select a set of task progress words that is associated with the selected project task, from among a plurality of sets of task progress keywords that have been defined for respective ones of the plurality of project tasks. The computer 100 can compare 322 the words in the text strings, which are received in the data packet, to the task progress keywords in the set that was selected. The collaborative speech processing computer 100 can then generate task metrics based on the comparison, such as by generating the task metrics based on which of the words in the text strings match which of the keywords of the task progress keywords is the set selected. Different keywords can have different defined weighted scores, and the task metrics may be generated based on mathematically combining the weighted scores for each of the keywords that are matched to words in the text strings. The mathematically combining may be controlled based on one or more defined rules to, for example, control how many instances of matches between a word in the text strings to one of the keywords is factored into the generated task metric.

The operation for generating the task metrics based on which of the words in the text strings match which of the keywords in the set of task progress keywords selected, can include: 1) identifying which task milestone names identified by the set of task progress keywords are discussed in the text strings; 2) identifying which task member names identified by the set of task progress keywords are discussed in the text strings; 3) identifying which supplier names identified by the set of task progress keywords are discussed in the text strings; and/or 4) identifying which customer names identified by the set of task progress keywords are discussed in the text strings. Again, different keywords can have different defined weighted scores, and the task metrics may be generated based on mathematically combining the weighted scores for each of the keywords that are matched to words in the text strings.

In another embodiment, the operation for generating the task metrics based on processing (214 in FIG. 2) elements of the dialog data structure through a project ruleset, can include identifying 326 risk to progress of the project task based on determining which of the keywords in the set of task progress keywords selected are absent from among the words in the text strings. The collaborative speech processing computer 100 may control how many different types of task metrics are generated and used to update elements of the project data structure in the database server, based on the risk identified.

In another embodiment, the operation for generating the task metrics based on processing (214 in FIG. 2) elements of the dialog data structure through a project ruleset, can include querying 328 the project database 102 using the selected project task as an index, to obtain a set of task risk keywords. Project database 102 may contain task risk keywords that are common to a set of project tasks and/or may contain sets of task risk keywords that are associated with different project tasks. The collaborative speech processing computer can compare words that are parsed from the text strings to keywords in a set of task risk keywords, and generate 330 the task metrics based on which of the words in the text strings match which of the keywords in the set of task risk keywords.

In another embodiment, the operation for generating the task metrics based on processing (214 in FIG. 2) elements of the dialog data structure through a project ruleset, can include selecting a project task from among a plurality of project tasks defined in the project database 102 based on a closest matching of words in the one of the text strings to a set of keywords for the project task that is among sets of keywords that have been defined for the plurality of project tasks. The computer 100 tracks how long the project task remains selected based on the continuing determination of its closest matching between words in subsequent ones of the text strings to the set of keywords defined for the project task, until another project task is selected based on its greater closeness of matching, and generates the task metrics based on how long the project task remained selected.

In a further embodiment, the operations for generating the task metrics based on how long the project task remains selected, can include identifying risk to progress of the project task based on changes over time between how long the project task remained selected during a plurality of collaboration meetings between persons that are performed over the time.

The collaborative speech processing computer 100 can add 340 the task metrics to the project database 102.

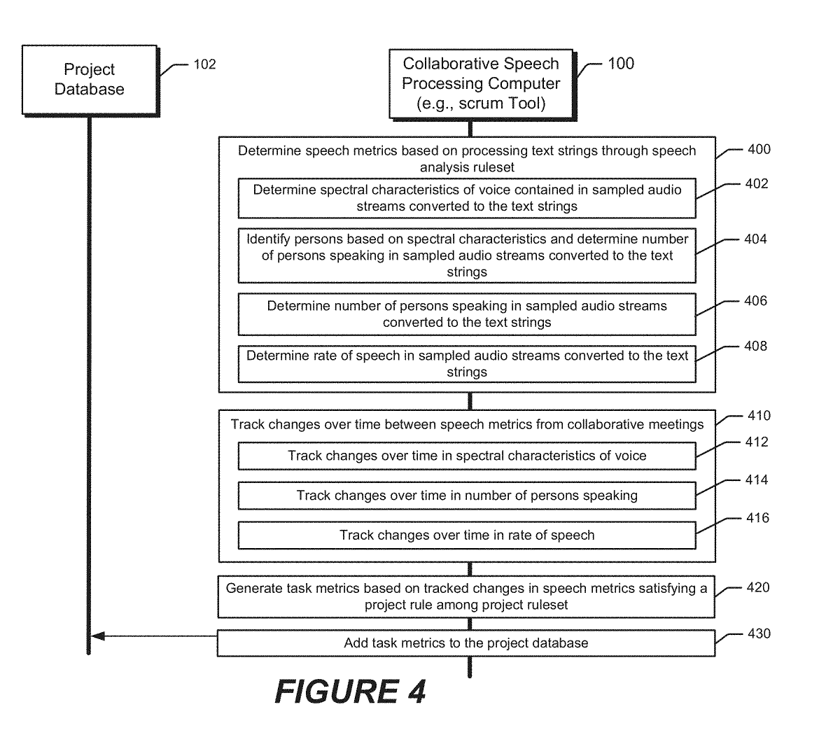

FIG. 4 is a combined data flow diagram and flowchart of some other operations that may be performed by the project database 102 and the collaborative speech processing computer 100 of FIG. 1 in accordance with some other embodiments.

Referring to FIG. 4, the operations for generating 214 the task metrics according to FIG. 2 based on processing elements of the dialog data structure through a project ruleset, can include determining 400 speech metrics based on processing the text strings, received in the data packets, through one or more speech analysis rulesets. Operations track 410 changes over time between the speech metrics generated for a plurality of collaboration meetings that are performed over the time, and generate 420 the task metrics based on determining whether the tracked changes over time between the speech metrics satisfy a project rule among the project ruleset. The task metrics are then added 430 to the project database 102.

In one embodiment, the operations for determining 400 the speech metrics based on processing the text strings through the speech analysis ruleset, includes determining 402 spectral characteristics of a voice contained in one of the sampled audio streams which was converted to the one of the text strings. The operations to track 410 changes over time, can then include tracking 412 changes over time in the spectral characteristics characterized for the voice contained in the sampled audio streams for the plurality of collaboration meetings.

For example, statistically tracking the loudness and/or pitch of voices during one or more collaboration meetings and determining a trend in the loudness and/or pitch of the voices across a plurality of collaboration meetings may be used to identify possible higher and lower levels of anxiety and/or confidence in what is being said by the meeting participant speakers regarding certain identified project tasks. Similarly, statistically tracking the length of words used to express opinions by meeting participant speakers may be used to identify possible higher and lower levels of anxiety and/or confidence in what is being said by the meeting participant speakers.

In another embodiment, the operations for determining 400 the speech metrics based on processing the text strings through the speech analysis ruleset, include identifying 404 persons based on the spectral characteristics, and determining 406 a number of persons who are speaking in the sample audio streams which have been converted to the text strings. The operations to track 410 changes over time, can then include tracking 414 changes over time in the number of different persons speaking in the sampled audio streams for the plurality of collaboration meetings.

For example, statistically tracking the number of persons who are contributing during different collaboration meetings to the discussion of particular project tasks can be used to identify how much corresponding effort is being devoted to those particular project tasks and which, in turn, can indicate a level of completion or associative risk with completion of the project tasks.

In another embodiment, the operations for determining 400 the speech metrics based on processing the text strings through the speech analysis ruleset, include determining 408 a rate of speech in one of the sampled audio streams which was converted to the one of the text strings. The operations to track 410 changes over time, can then include tracking 416 changes over time in the rate of speech in the sampled audio streams for the plurality of collaboration meetings.

For example, statistically tracking the rate of speech used to express opinions by meeting participant speakers may be used to identify possible higher and lower levels of anxiety and/or confidence in what is being said by the meeting participant speakers regarding certain identified project tasks.

In another embodiment, the operations for determining 400 the speech metrics based on processing the text strings through the speech analysis ruleset, include determining a rate of interruptions due to time-overlapping speech contained in one of the sampled audio streams which was converted to the one of the text strings. The operations to track 410 changes over time, can then include tracking changes over time in the rate of interruptions due to time-overlapping speech contained in the sampled audio streams for the plurality of collaboration meetings.

For example, statistically tracking the rate of interruptions occurring during discussions by meeting participant speakers may be used to identify possible higher and lower levels of anxiety and/or confidence in what is being said by the meeting participant speakers regarding certain identified project tasks.

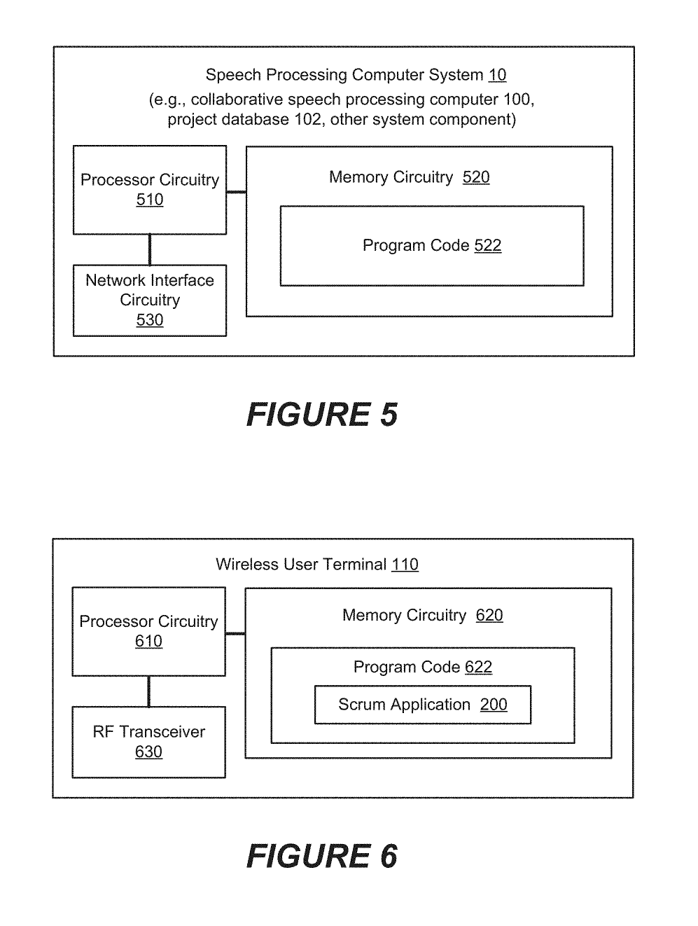

FIG. 5 is a block diagram of a speech processing computer system 10 that can be configured to perform operations in accordance with some embodiments. The system 10 can include the collaborative speech processing computer 100, the project database 102, and/or other system components configured to operate according one or more embodiments herein. Referring to FIG. 5, the system 10 can include network interface circuitry 530 which communicates via the one or more data networks 122 and/or 124 with the radio access network 120, the project database 102, the natural language speech-to-text server 130, and/or other components of the system 10. The system 10 includes processor circuitry 510 (hereinafter “processor”) and memory circuitry 530 (hereinafter “memory”) that contains computer program code nine twenty-two which performs various operations disclosed herein when executed by the processor 510. The processor 510 may include one or more data processing circuits, such as a general purpose and/or special purpose processor (e.g., microprocessor and/or digital signal processor), which may be collocated or distributed across one or more data networks (e.g., network(s) 124 and/or 122). The processor 510 is configured to execute computer program instructions among the program code 522 in the memory 520, described below as a computer readable medium, to perform some or all of the operations and methods for one or more of the embodiments disclosed herein.

FIG. 6 is a block diagram of a user terminal 110, e.g., a wired user terminal or a wireless user terminal, that can be configured to perform operations in accordance with some embodiments. Referring to FIG. 6, the terminal 110 can include a RF transceiver circuit 630 which use RF signaling according to one or more wireless communication protocols to communicate with the radio access network 120, and/or may include a wired network interface (e.g., Ethernet, USB, etc.). The wireless communication protocols can include, but are not limited to, wireless local area network (e.g., IEEE 802.11), Bluetooth, and/or one or more 3GPP cellular communication protocols such as 4G, 5G, etc. The terminal 110 includes processor circuitry 610 (hereinafter “processor”) and memory circuitry 620 (hereinafter “memory”) that contains computer program code 622 which performs various operations disclosed herein when executed by the processor 610. Program code 622 can include the scrum application 200 described herein. The processor 610 may include one or more data processing circuits, such as a general purpose and/or special purpose processor (e.g., microprocessor and/or digital signal processor), which may be collocated or distributed across one or more data networks (e.g., network(s) 124 and/or 122). The processor 610 is configured to execute computer program instructions among the program code 622 in the memory 620, described below as a computer readable medium, to perform some or all of the operations and methods for one or more of the embodiments disclosed herein.

### FURTHER DEFINITIONS AND EMBODIMENTS

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “i” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method by a collaborative speech processing computer comprising:
obtaining data packets of sampled audio streams;
forwarding the data packets to a speech-to-text conversion server via a data network;
receiving, via the data network, data packets containing text strings converted from the sampled audio steams by the speech-to-text conversion server;
adding the text strings to a dialog data structure in a repository memory;
generating task metrics based on processing elements of the dialog data structure through a project ruleset; and
maintaining elements of a project data structure in a database server based on the task metrics generated.

2. The method of claim 1, further comprising:
identifying speakers associated with the text strings contained in the data packets; and
adding the identifiers of the associated speakers to the dialog data structure in the repository memory with indications of their respective associations to the text strings.

3. The method of claim 2,
wherein identifying one of the speakers associated with one of the text strings contained in the data packets, comprises:
selecting a project task from among a plurality of project tasks defined in a project database based on a closest matching of words in the one of the text strings to a set of keywords for the project task that is among sets of keywords that have been defined for the plurality of project tasks; and
identifying as the speaker a person who is defined in the project database as being associated with the project task selected; and
wherein adding the identifiers of the associated speakers to the dialog data structure in the repository memory with indications of their respective associations to the text strings, comprises:
storing the one of the text strings and an identifier of the person who is identified as the speaker, to the project data structure with a defined association to the project task selected.

4. The method of claim 3, wherein identifying as the speaker a person who is defined in the project database as being associated with the project task selected, comprises:
comparing spectral characteristics of a voice contained in the sampled audio stream, which was converted to the one of the text strings, to spectral characteristics that are defined for a plurality of persons who are identified by the project database as being associated with the project task selected; and
selecting one person as the speaker from among the plurality of persons who are identified by the project database as being associated with the project task selected, based on a relatively closeness of the comparisons of spectral characteristics.

5. The method of claim 1, wherein generating task metrics based on processing elements of the dialog data structure through a project ruleset, comprises:
selecting a project task from among a plurality of project tasks defined in a project database based on a closest matching of words in the one of the text strings to a set of keywords for the project task that is among sets of keywords that have been defined for the plurality of project tasks;
tracking how long the project task remains selected based on the continuing determination of its closest matching between words in subsequent ones of the text strings to the set of keywords defined for the project task, until another project task is selected based on its greater closeness of matching; and
generating the task metrics based on how long the project task remained selected.

6. The method of claim 5, wherein generating the task metrics based on how long the project task remained selected, further comprises:
identifying risk to progress of the project task based on changes over time between how long the project task remained selected during a plurality of collaboration meetings between persons that are performed over the time.

7. The method of claim 1, wherein generating task metrics based on processing elements of the dialog data structure through a project ruleset, comprises:
selecting a project task from among a plurality of project tasks defined in a project database;
selecting a set of task progress keywords from among a plurality of sets of task progress keywords that have been defined for respective ones of the plurality of project tasks, based on the project task selected;
comparing words in the text strings to the task progress keywords in the set selected; and
generating the task metrics based on which of the words in the text strings match which of the keywords of the task progress keywords is the set selected.

8. The method of claim 7, wherein generating the task metrics based on which of the words in the text strings match which of the keywords in the set of task progress keywords selected, comprises at least two of:
identifying which task milestone names identified by the set of task progress keywords are discussed in the text strings;
identifying which task member names identified by the set of task progress keywords are discussed in the text strings;
identifying which supplier names identified by the set of task progress keywords are discussed in the text strings; and
identifying which customer names identified by the set of task progress keywords are discussed in the text strings.

9. The method of claim 7, wherein generating task metrics based on processing elements of the dialog data structure through a project ruleset, further comprises:
identifying risk to progress of the project task based on determining which of the keywords in the set of task progress keywords selected are absent from among the words in the text strings.

10. The method of claim 9, further comprising:
controlling how many different types of task metrics are generated and used to update elements of the project data structure in the database server, based on the risk identified.

11. The method of claim 7, wherein generating task metrics based on processing elements of the dialog data structure through a project ruleset, further comprises:
comparing words in the text strings to keywords in a set of task risk keywords; and
generating the task metrics based on which of the words in the text strings match which of the keywords in the set of task risk keywords.

12. The method of claim 1, wherein generating task metrics based on processing elements of the dialog data structure through a project ruleset, comprises:
determining speech metrics based on processing the text strings in the dialog data structure through a speech analysis ruleset;
tracking changes over time between the speech metrics generated for a plurality of collaboration meetings that are performed over the time; and
generating the task metrics based on determining whether the tracked changes over time between the speech metrics satisfy a project rule among the project ruleset.

13. The method of claim 12, wherein:
determining speech metrics based on processing the text strings in the dialog data structure through a speech analysis ruleset, comprises characterizing spectral characteristics of a voice contained in one of the sampled audio streams which was converted to the one of the text strings; and
tracking changes over time between the speech metrics generated for a plurality of collaboration meetings that are performed over the time, comprises tracking changes over time in the spectral characteristics characterized for the voice contained in the sampled audio streams for the plurality of collaboration meetings.

14. The method of claim 12, wherein:
determining speech metrics based on processing the text strings in the dialog data structure through a speech analysis ruleset, comprises determining a number of different persons speaking in one of the sampled audio streams which was converted to the one of the text strings; and
tracking changes over time between the speech metrics generated for a plurality of collaboration meetings between persons that are performed over the time, comprises tracking changes over time in the number of different persons speaking in the sampled audio streams for the plurality of collaboration meetings.

15. The method of claim 12, wherein:
determining speech metrics based on processing the text strings in the dialog data structure through a speech analysis ruleset, comprises determining a rate of speech in one of the sampled audio streams which was converted to the one of the text strings; and
tracking changes over time between the speech metrics generated for a plurality of collaboration meetings between persons that are performed over the time, comprises tracking changes over time in the rate of speech in the sampled audio streams for the plurality of collaboration meetings.

16. The method of claim 12, wherein:
determining speech metrics based on processing the text strings in the dialog data structure through a speech analysis ruleset, comprises determining a rate of interruptions due to time-overlapping speech contained in one of the sampled audio streams which was converted to the one of the text strings; and
tracking changes over time between the speech metrics generated for a plurality of collaboration meetings between persons that are performed over the time, comprises tracking changes over time in the rate of interruptions due to time-overlapping speech contained in the sampled audio streams for the plurality of collaboration meetings.

17. A collaborative speech processing computer comprising:
a network interface configured to communicate with a speech-to-text conversion server;
a processor connected to receive the data packets from the network interface; and
a memory storing program instructions executable by the processor to perform operations comprising:
obtaining data packets of sampled audio streams;
forwarding the data packets to the speech-to-text conversion server via the network interface;
receiving, via the network interface, data packets containing text strings converted from the sampled audio steams by the speech-to-text conversion server;
selecting a project task from among a plurality of project tasks defined in a project database;
selecting a set of task progress keywords from among a plurality of sets of task progress keywords that have been defined for respective ones of the plurality of project tasks, based on the project task selected;
comparing words in the text strings to the task progress keywords in the set selected;
generating task metrics based on which of the words in the text strings match which of the keywords of the task progress keywords is the set selected; and
controlling updating of elements of a project data structure in a database server based on the task metrics generated.

18. The collaborative speech processing computer of claim 17, wherein the operations further comprise:
identifying risk to progress of the project task based on determining which of the keywords in the set of task progress keywords selected are absent from among the words in the text strings; and
controlling how many different types of task metrics are generated for updating elements of the project data structure in the database server, based on the risk identified.

19. A collaborative speech processing computer comprising:
a network interface configured to communicate with a speech-to-text conversion server;
a processor connected to receive the data packets from the network interface; and
a memory storing program instructions executable by the processor to perform operations comprising:
obtaining data packets of sampled audio streams;
forwarding the data packets to the speech-to-text conversion server via the network interface;
receiving, via the network interface, data packets containing text strings converted from the sampled audio steams by the speech-to-text conversion server;
determining speech metrics based on processing the text strings in the dialog data structure through a speech analysis ruleset;
tracking changes over time between the speech metrics generated for a plurality of collaboration meetings between persons that are performed over the time;
generating task metrics based on determining whether the tracked changes over time between the speech metrics satisfy a project rule among a project ruleset; and
controlling updating of elements of a project data structure in a database server based on the task metrics generated.

20. The collaborative speech processing computer of claim 19, wherein:
determining speech metrics based on processing the text strings in the dialog data structure through a speech analysis ruleset, comprises characterizing spectral characteristics of a voice contained in one of the sampled audio streams which was converted to the one of the text strings; and
tracking changes over time between the speech metrics generated for a plurality of collaboration meetings between persons that are performed over the time, comprises tracking changes over time in the spectral characteristics that are characterized for the voice contained in the sampled audio streams for the plurality of collaboration meetings.
